(19) United States
(12) Patent Application Publication
(10) Pub. No.: US 2005/0005886 A1
(43) Pub. Date: Jan. 13, 2005

(54) Method for reducing VCT low speed closed loop excessive response time

(75) Inventor: Zhenyu Jiang, Ithaca, NY (US)

Correspondence Address: BORGWARNER INC., POWERTRAIN TECHNICAL CENTER, 3800 AUTOMATION AVENUE, SUITE 100, AUBURN HILLS, MI, 48326-1782, US

(73) Assignee: BorgWarner Inc., Auburn Hills, MI (US)

(21) Appl. No.: 10/616,822

(22) Filed: Jul. 10, 2003

(51) Int. Cl. F01L 1/34; F02D 1/00

(52) U.S. Cl. 123/90.17; 123/90.15

(57) ABSTRACT

A method suitable for implementation in a computer product for Variable Cam Timing (VCT) closed-loop control system includes a set point filter to smooth out any abrupt change of a set point and also reduces the closed-loop control system overshoot. At low engine speed, however, the closed-loop control system may introduce excessive response time when forcing the VCT to follow the filtered set point. Therefore, instead of using the original filtered set point other set point values are used. By modifying error zero signal in the closed-loop control system, this invention eliminates the excessive response time introduced by the set point filter.

### FIELD OF THE INVENTION

The invention pertains to the field of variable cam timing (VCT). More particularly, the invention pertains to a method for reducing VCT low speed closed loop excessive response time using error zero treatment

### BACKGROUND OF THE INVENTION

The performance of an internal combustion engine can be improved by the use of dual camshafts, one to operate the intake valves of the various cylinders of the engine and the other to operate the exhaust valves. Typically, one of such camshafts is driven by the crankshaft of the engine, through a sprocket and chain drive or a belt drive, and the other of such camshafts is driven by the first, through a second sprocket and chain drive or a second belt drive. Alternatively, both of the camshafts can be driven by a single crankshaft powered chain drive or belt drive. Engine performance in an engine with dual camshafts can be further improved, in terms of idle quality, fuel economy, reduced emissions or increased torque, by changing the positional relationship of one of the camshafts, usually the camshaft which operates the intake valves of the engine, relative to the other camshaft and relative to the crankshaft, to thereby vary the timing of the engine in terms of the operation of intake valves relative to its exhaust valves or in terms of the operation of its valves relative to the position of the crankshaft.

Consideration of information disclosed by the following U.S. Patents, which are all hereby incorporated by reference, is useful when exploring the background of the present invention.

U.S. Pat. No. 5,002,023 describes a VCT system within the field of the invention in which the system hydraulics includes a pair of oppositely acting hydraulic cylinders with appropriate hydraulic flow elements to selectively transfer hydraulic fluid from one of the cylinders to the other, or vice versa, to thereby advance or retard the circumferential position on of a camshaft relative to a crankshaft. The control system utilizes a control valve in which the exhaustion of hydraulic fluid from one or another of the oppositely acting cylinders is permitted by moving a spool within the valve one way or another from its centered or null position. The movement of the spool occurs in response to an increase or decrease in control hydraulic pressure, P_{C}, on one end of the spool and the relationship between the hydraulic force on such end and an oppositely direct mechanical force on the other end which results from a compression spring that acts thereon.

U.S. Pat. No. 5,107,804 describes an alternate type of VCT system within the field of the invention in which the system hydraulics include a vane having lobes within an enclosed housing which replace the oppositely acting cylinders disclosed by the aforementioned U.S. Pat. No. 5,002,023. The vane is oscillatable with respect to the housing, with appropriate hydraulic flow elements to transfer hydraulic fluid within the housing from one side of a lobe to the other, or vice versa, to thereby oscillate the vane with respect to the housing in one direction or the other, an action which is effective to advance or retard the position of the camshaft relative to the crankshaft. The control system of this VCT system is identical to that divulged in U.S. Pat. No. 5,002,023, using the same type of spool valve responding to the same type of forces acting thereon.

U.S. Pat. Nos. 5,172,659 and 5,184,578 both address the problems of the aforementioned types of VCT systems created by the attempt to balance the hydraulic force exerted against one end of the spool and the mechanical force exerted against the other end. The improved control system disclosed in both U.S. Pat. Nos. 5,172,659 and 5,184,578 utilizes hydraulic force on both ends of the spool. The hydraulic force on one end results from the directly applied hydraulic fluid from the engine oil gallery at full hydraulic pressure, P_{S}. The hydraulic force on the other end of the spool results from a hydraulic cylinder or other force multiplier which acts thereon in response to system hydraulic fluid at reduced pressure, P_{C}, from a PWM solenoid. Because the force at each of the opposed ends of the spool is hydraulic in origin, based on the same hydraulic fluid, changes in pressure or viscosity of the hydraulic fluid will be self-negating, and will not affect the centered or null position of the spool.

U.S. Pat. No. 5,289,805 provides an improved VCT method which utilizes a hydraulic PWM spool position control and an advanced control method suitable for computer implementation that yields a prescribed set point tracking behavior with a high degree of robustness.

In U.S. Pat. No. 5,361,735, a camshaft has a vane secured to an end for non-oscillating rotation. The camshaft also carries a timing belt driven pulley which can rotate with the camshaft but which is oscillatable with respect to the camshaft. The vane has opposed lobes which are received in opposed recesses, respectively, of the pulley. The camshaft tends to change in reaction to torque pulses which it experiences during its normal operation and it is permitted to advance or retard by selectively blocking or permitting the flow of engine oil from the recesses by controlling the position of a spool within a valve body of a control valve in response to a signal from an engine control unit. The spool is urged in a given direction by rotary linear motion translating means which is rotated by an electric motor, preferably of the stepper motor type.

U.S. Pat. No. 5,497,738 shows a control system which eliminates the hydraulic force on one end of a spool resulting from directly applied hydraulic fluid from the engine oil gallery at full hydraulic pressure, P_{S}, utilized by previous embodiments of the VCT system. The force on the other end of the vented spool results from an electromechanical actuator, preferably of the variable force solenoid type, which acts directly upon the vented spool in response to an electronic signal issued from an engine control unit (“ECU”) which monitors various engine parameters. The ECU receives signals from sensors corresponding to camshaft and crankshaft positions and utilizes this information to calculate a relative phase angle. A closed-loop feedback system which corrects for any phase angle error is preferably employed. The use of a variable force solenoid solves the problem of sluggish dynamic response. Such a device can be designed to be as fast as the mechanical response of the spool valve, and certainly much faster than the conventional (fully hydraulic) differential pressure control system. The faster response allows the use of increased closed-loop gain, making the system less sensitive to component tolerances and operating environment.

U.S. Pat. No. 5,657,725 shows a control system which utilizes engine oil pressure for actuation. The system includes A camshaft has a vane secured to an end thereof for non-oscillating rotation therewith. The camshaft also carries a housing which can rotate with the camshaft but which is oscillatable with the camshaft. The vane has opposed lobes which are received in opposed recesses, respectively, of the housing. The recesses have greater circumferential extent than the lobes to permit the vane and housing to oscillate with respect to one another, and thereby permit the camshaft to change in phase relative to a crankshaft. The camshaft tends to change direction in reaction to engine oil pressure and/or camshaft torque pulses which it experiences during its normal operation, and it is permitted to either advance or retard by selectively blocking or permitting the flow of engine oil through the return lines from the recesses by controlling the position of a spool within a spool valve body in response to a signal indicative of an engine operating condition from an engine control unit. The spool is selectively positioned by controlling hydraulic loads on its opposed end in response to a signal from an engine control unit. The vane can be biased to an extreme position to provide a counteractive force to a unidirectionally acting frictional torque experienced by the camshaft during rotation.

U.S. Pat. No. 6,247,434 shows a multi-position variable camshaft timing system actuated by engine oil. Within the system, a hub is secured to a camshaft for rotation synchronous with the camshaft, and a housing circumscribes the hub and is rotatable with the hub and the camshaft and is further oscillatable with respect to the hub and the camshaft within a predetermined angle of rotation. Driving vanes are radially disposed within the housing and cooperate with an external surface on the hub, while driven vanes are radially disposed in the hub and cooperate with an internal surface of the housing. A locking device, reactive to oil pressure, prevents relative motion between the housing and the hub. A controlling device controls the oscillation of the housing relative to the hub.

U.S. Pat. No. 6, 250,265 shows a variable valve timing system with actuator locking for internal combustion engine. The system comprising a variable camshaft timing system comprising a camshaft with a vane secured to the camshaft for rotation with the camshaft but not for oscillation with respect to the camshaft. The vane has a circumferentially extending plurality of lobes projecting radially outwardly therefrom and is surrounded by an annular housing that has a corresponding plurality of recesses each of which receives one of the lobes and has a circumferential extent greater than the circumferential extent of the lobe received therein to permit oscillation of the housing relative to the vane and the camshaft while the housing rotates with the camshaft and the vane. Oscillation of the housing relative to the vane and the camshaft is actuated by pressurized engine oil in each of the recesses on opposed sides of the lobe therein, the oil pressure in such recess being preferably derived in part from a torque pulse in the camshaft as it rotates during its operation. An annular locking plate is positioned coaxially with the camshaft and the annular housing and is moveable relative to the annular housing along a longitudinal central axis of the camshaft between a first position, where the locking plate engages the annular housing to prevent its circumferential movement relative to the vane and a second position where circumferential movement of the annular housing relative to the vane is permitted. The locking plate is biased by a spring toward its first position and is urged away from its first position toward its second position by engine oil pressure, to which it is exposed by a passage leading through the camshaft, when engine oil pressure is sufficiently high to overcome the spring biasing force, which is the only time when it is desired to change the relative positions of the annular housing and the vane. The movement of the locking plate is controlled by an engine electronic control unit either through a closed loop control system or an open loop control system.

U.S. Pat. No. 6, 263,846 shows a control valve strategy for vane-type variable camshaft timing system. The strategy involves an internal combustion engine that includes a camshaft and hub secured to the camshaft for rotation therewith, where a housing circumscribes the hub and is rotatable with the hub and the camshaft, and is further oscillatable with respect to the hub and camshaft. Driving vanes are radially inwardly disposed in the housing and cooperate with the hub, while driven vanes are radially outwardly disposed in the hub to cooperate with the housing and also circumferentially alternate with the driving vanes to define circumferentially alternating advance and retard chambers. A configuration for controlling the oscillation of the housing relative to the hub includes an electronic engine control unit, and an advancing control valve that is responsive to the electronic engine control unit and that regulates engine oil pressure to and from the advance chambers. A retarding control valve responsive to the electronic engine control unit regulates engine oil pressure to and from the retard chambers. An advancing passage communicates engine oil pressure between the advancing control valve and the advance chambers, while a retarding passage communicates engine oil pressure between the retarding control valve and the retard chambers.

U.S. Pat. No. 6,311,655 shows multi-position variable cam timing system having a vane-mounted locking-piston device. An internal combustion engine having a camshaft and variable camshaft timing system, wherein a rotor is secured to the camshaft and is rotatable but non-oscillatable with respect to the camshaft is discribed. A housing circumscribes the rotor, is rotatable with both the rotor and the camshaft, and is further oscillatable with respect to both the rotor and the camshaft between a fully retarded position and a fully advanced position. A locking configuration prevents relative motion between the rotor and the housing, and is mounted within either the rotor or the housing, and is respectively and releasably engageable with the other of either the rotor and the housing in the fully retarded position, the fully advanced position, and in positions therebetween. The locking device includes a locking piston having keys terminating one end thereof, and serrations mounted opposite the keys on the locking piston for interlocking the rotor to the housing. A controlling configuration controls oscillation of the rotor relative to the housing.

U.S. Pat. No. 6,374,787 shows a multi-position variable camshaft timing system actuated by engine oil pressure. A hub is secured to a camshaft for rotation synchronous with the camshaft, and a housing circumscribes the hub and is rotatable with the hub and the camshaft and is further oscillatable with respect to the hub and the camshaft within a predetermined angle of rotation. Driving vanes are radially disposed within the housing and cooperate with an external surface on the hub, while driven vanes are radially disposed in the hub and cooperate with an internal surface of the housing. A locking device, reactive to oil pressure, prevents relative motion between the housing and the hub. A controlling device controls the oscillation of the housing relative to the hub.

U.S. Pat. No. 6,477,999 shows a camshaft that has a vane secured to an end thereof for non-oscillating rotation therewith. The camshaft also carries a sprocket that can rotate with the camshaft but is oscillatable with respect to the camshaft. The vane has opposed lobes that are received in opposed recesses, respectively, of the sprocket. The recesses have greater circumferential extent than the lobes to permit the vane and sprocket to oscillate with respect to one another. The camshaft phase tends to change in reaction to pulses that it experiences during its normal operation, and it is permitted to change only in a given direction, either to advance or retard, by selectively blocking or permitting the flow of pressurized hydraulic fluid, preferably engine oil, from the recesses by controlling the position of a spool within a valve body of a control valve. The sprocket has a passage extending therethrough the passage extending parallel to and being spaced from a longitudinal axis of rotation of the camshaft. A pin is slidable within the passage and is resiliently urged by a spring to a position where a free end of the pin projects beyond the passage. The vane carries a plate with a pocket, which is aligned with the passage in a predetermined sprocket to camshaft orientation. The pocket receives hydraulic fluid, and when the fluid pressure is at its normal operating level, there will be sufficient pressure within the pocket to keep the free end of the pin from entering the pocket. At low levels of hydraulic pressure, however, the free end of the pin will enter the pocket and latch the camshaft and the sprocket together in a predetermined orientation.

Known methods suitable for a computer product for Variable Cam Timing (VCT) closed-loop control system may include a set point filter to smooth out any abrupt change of a set point. The set point filter gradually changes as a result of the above set point filtering. The gradual change of the set point renders the difference between the filtered set point and the measured phase (error zero E0) change gradually as well. Since the control output is directly related to error zero, the overall effect or result of filtering a set point is a smooth control output. More particularly for a closed-loop control VCT system, less overshoot is the result.

Referring to FIG. 1, a known overall VCT closed-loop control system without the set point filter is shown. Referring to FIG. 1, a prior art feedback loop 10 is shown. The control objective of feedback loop 10 is to have a spool valve in a null position. In other words, the objective is to have no fluid flowing between two fluid holding chambers of a phaser (not shown) such that the VCT mechanism at the phase angle given by a set point 12 with the spool 14 stationary in its null position. This way, the VCT mechanism is at the correct phase position and the phase rate of change is zero. A control computer program product which utilizes the dynamic state of the VCT mechanism is used to accomplish the above state.

The VCT closed-loop control mechanism is achieved by measuring a camshaft phase shift θ₀ 16, and comparing the same to the desired set point 12. The VCT mechanism is in turn adjusted so that the phaser achieves a position which is determined by the set point 12. A control law 18 compares the set point 12 to the phase shift θ₀ 16. The compared result is used as a reference to issue commands to a solenoid 20 to position the spool 14. This positioning of spool 14 occurs when the phase error (the difference between set point 12 and phase shift 20) is non-zero.

The spool 14 is moved toward a first direction (e.g. right) if the phase error is negative (retard) and to a second direction (e.g.. left) if the phase error is positive (advance). It is noted that the retarding with current phase measurement scheme gives a larger value, and advancing yields a small value. When the phase error is zero, the VCT phase equals the set point 12 so the spool 14 is held in the null position such that no fluid flows within the spool valve.

Camshaft and crankshaft measurement pulses in the VCT system are generated by camshaft and crankshaft pulse wheels 22 and 24, respectively. As the crankshaft (not shown) and camshaft (also not shown) rotate, wheels 22, 24 rotate along with them. The wheels 22, 24 possess teeth which can be sensed and measured by sensors according to measurement pulses generated by the sensors. The measurement pulses are detected by camshaft and crankshaft measurement pulse sensors 22a and 24a, respectively. The sensed pulses are used by a phase measurement device 26. A measurement phase difference is then determined. The phase between a cam shaft and a crankshaft is defined as the time from successive crank-to-cam pulses, divided by the time for an entire revolution and multiplied by 360.degree. The measured phase may be expressed as θ₀ 16. This phase is then supplied to the control law 18 for reaching the desired spool position.

A control law 18 of the closed-loop 10 is described in United Pat. No. 5,184,578 and is hereby incorporate herein by reference. A more detailed depiction of the control law along with a set point filter 30 is shown in FIG. 2. Measured phase 26 is subjected to the control law 18 initially at block 18a wherein a Proportional-Integral (PI) process occurs. PI process is the sum of two sub-processes. The first sub-process includes amplification; and the second sub-process includes integration. Measured phase is further subjected to phase compensation at block 18b, where control signal is adjusted to increase the overall control system stability before it is sent out to drive the actuator, in the instant case, a variable force solenoid.

Referring to FIG. 2, a partial depiction of the known overall VCT closed-loop control system of FIG. 1 with the addition of a set point filter 30 is shown. Specifically set point filter 30 is interposed between set point 12 and control law 18. Further, control law 18 is shown is more detail for the digital implementation of the control law in FIG. 1.

By including the set point filter 30, new problems occur in that the VCT controller now forces the VCT to follow the filtered set point, instead of the original set point 12. One of the results of following the filtered set point is the introduction of a time factor or a time lag into the overall control scheme. An analysis of the time factor is included infra in the description of the preferred embodiment section of the present document.

### SUMMARY OF THE INVENTION

In a VCT system, response time (which is defined as the time between a set point change and the VCT reaches its commanded position) is shortened.

In a VCT system, response time is shortened by using set point value instead of the filtered set point value in a first neighborhood of set point.

Accordingly, in a VCT control system having a predetermined set point with a set point value and a set point filter filtering the set point and deriving a filtered set point value, the control system further has a control law for processing an error signal, a method is provided in which the method generates an error signal for reducing the excessive VCT response time caused by VCT undershooting its filtered set point. The method includes the steps of: providing an initial error; setting the initial error as the error subtracting the set point value from a phase value if a first set of conditions are met; and setting the difference of the above step as the error.

Accordingly, a VCT control system is provided which includes: a predetermined set point with a set point value; a set point filter filtering the set point and deriving a set point value; a control law for processing an error signal derived in part from the set point filter; and an error zero treatment block having the set point value and the filtered set point value. The error zero treatment block includes a method that generates an error signal for reducing the excessive VCT response time caused by VCT undershooting its filtered set point. The method includes the steps of: providing an initial error; setting the initial error as the error subtracting the set point value from a phase value if a first set of conditions are met; and setting the difference of the above step as the error.

Accordingly a computer program product suitable for implementing the above system and method therein is provided.

### BRIEF DESCRIPTION OF THE DRAWING

FIG. 1 shows a prior art closed loop control VCT system.

FIG. 2 shows a prior art VCT Control Law.

FIG. 3 shows Control Law with error zero (E0) Treatment of the present invention

FIG. 4 shows a flow chart for error zero (E0) Treatment of the present invention.

FIG. 5 shows a set of conditions where error zero is treated in the present invention.

FIG. 6 shows VCT low speed response without error zero E0 Treatment.

FIG. 7 shows VCT response with error zero E0 Treatment.

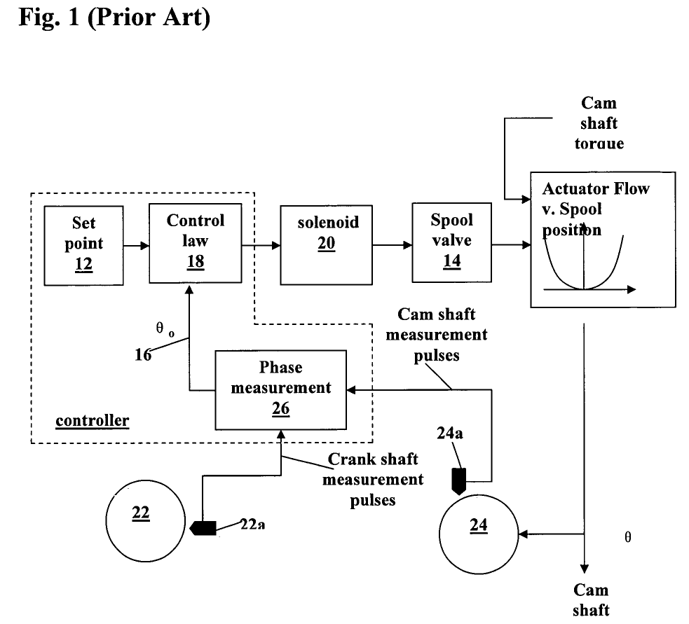

### DESCRIPTION OF THE PREFERRED EMBODIMENT

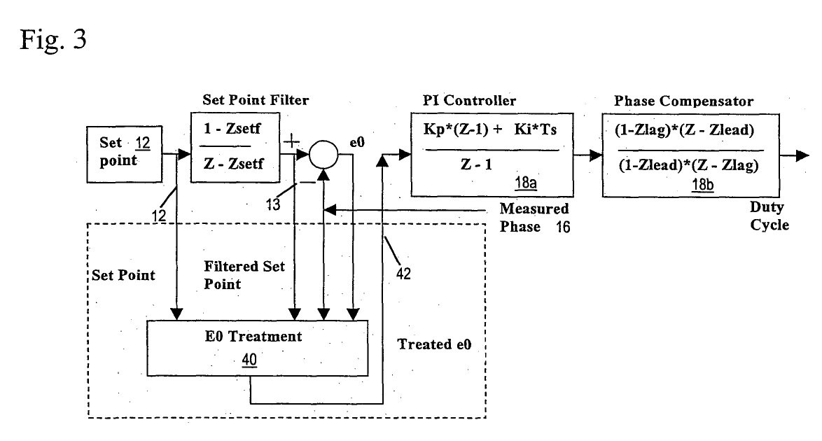

Referring to FIGS. 3-7, the new problems discussed in the background section of the present document include the following scenarios:

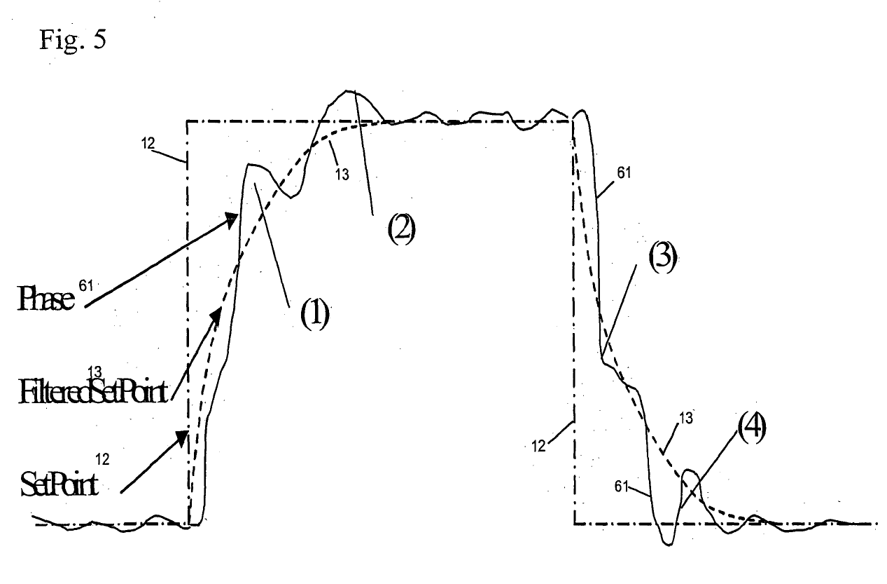

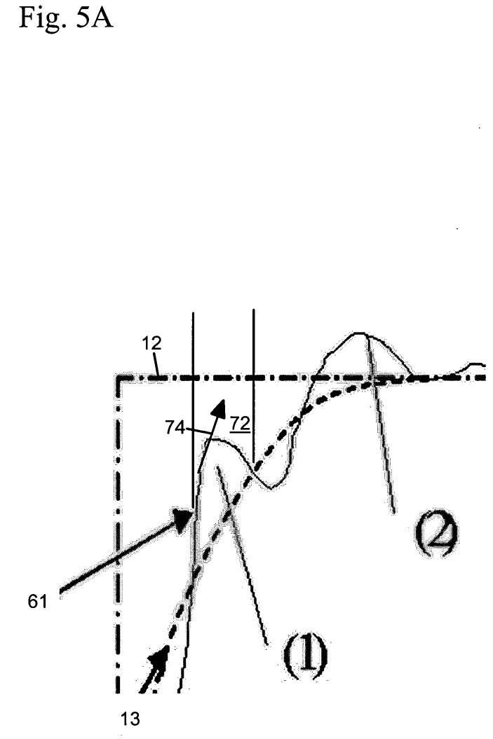

Scenario A: When the VCT phase response 61 has overshot the filtered set point 13, but not the set point 12 (i.e., in area interposed between the set point 12 curve and the filtered set point curve), the maintaining of the VCT motion is desirable. In other words, reducing the time lap is desirable. The VCT motion is defined as the movement of a phaser such as the oscillation of at least one vane therein maintaining the current direction toward a predetermined set point. However, the VCT controller (not shown) actually pulls the VCT rotor back towards the filtered set point 13, and causes the VCT to undershoot the filtered set point 13. The response time (which is defined as the time between a set point change and the VCT reaches its commanded position) is prolonged. See (1) in FIGS. 5 and 5A, where FIG. 5A is a blown up view of portions of FIG. 5.

A phase response is defined as a dynamic state, or the phaser motion following a control action. Using an analogy, the step response of a R-C circuit is the response during the dynamic state (change of current and voltage in the time domain) of a R-C circuit after apply a voltage to the circuit.

Scenario B: When the VCT phase 61 has overshot the set point 12 and the filtered set point 13 has not reached its steady state value, pulling the VCT 61 towards the set point 12 is enough. However, the VCT controller pulls the VCT 61 towards the filtered set point 13, which is more than required. This pulling of the VCT 61 towards filtered set point 13 is undesirable in that response time is lengthened. See region (4) in FIG. 5

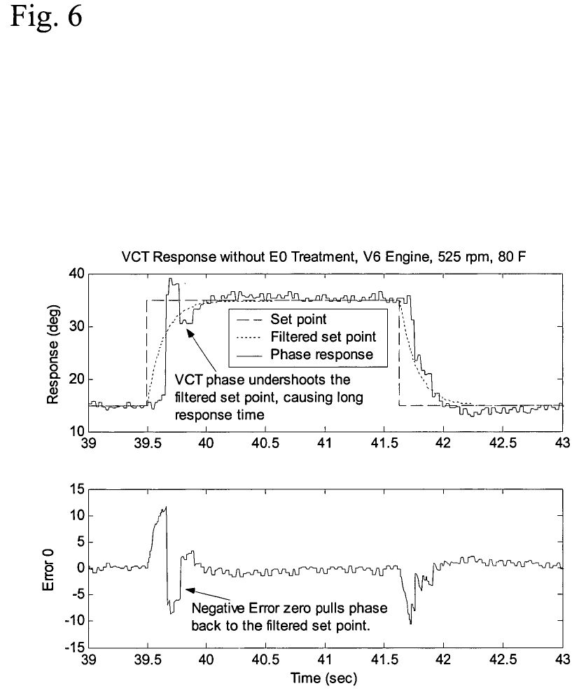

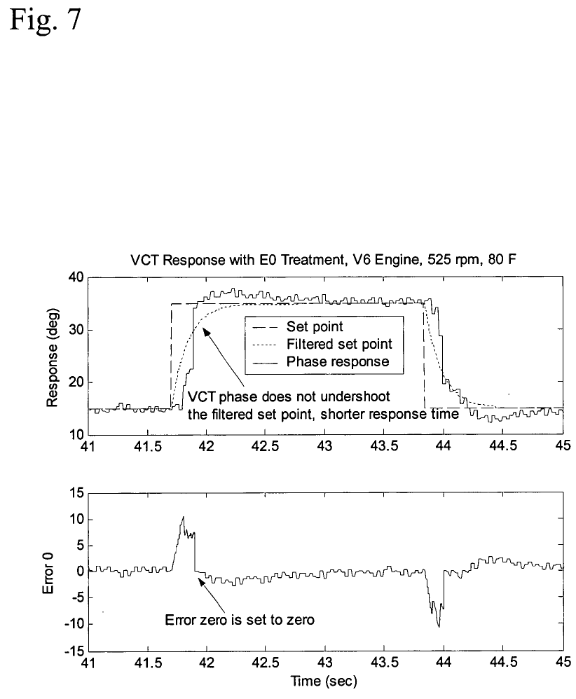

These two above scenarios of set point filtering in a VCT control loop can be improved by using an “Error Zero (E0) Treatment” method of the present invention, which is mentioned in general supra and will be discussed in detail infra. “E0 treatment” redefines error zero signal in the above two circumstances or scenarios. The result is shortened response time and more uniform overshoot albeit slightly higher valued overshoot. See the comparison between FIG. 6 and FIG. 7.

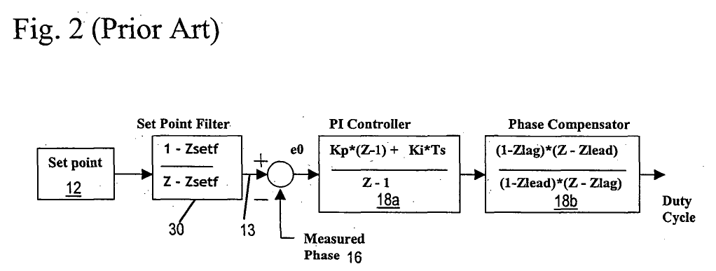

FIG. 3 is a diagram showing the addition of Error Zero Treatment block 40 onto FIG. 2. Block 40 receives as set point 12, filtered set point 13, measured phase 16, and E0. The block 40 processes the above parameters and produces a new or treated E0 42.

The variables in FIGS. 2 and 3 are defined as follows:
Z: Next control step;
Zsetf: Parameter for the first-order set point;
Kp: Proportional control gain;
Ki: Integral control gain;
Ts: Time interval between two consecutive control steps;
Zlead: Phase compensator lead parameter;
Zlag: Phase compensator lag parameter.

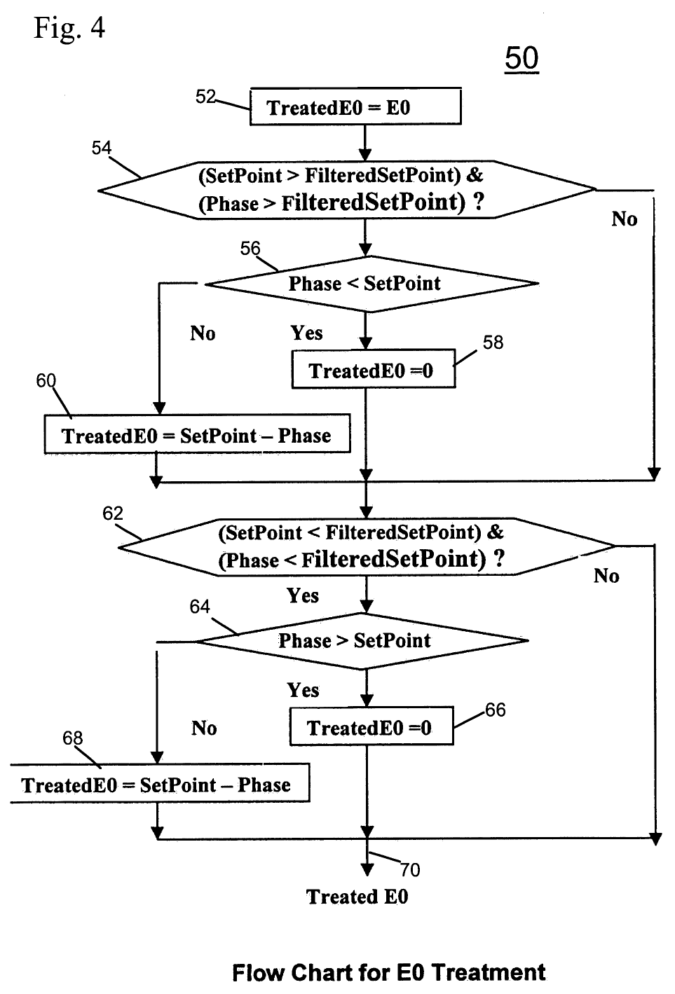

FIG. 4 is flow chart 50 which shows the added Error Zero Treatment block 40 of FIG. 3. Initial block 52 set treated E0 using the current or present E0. If the conditions in block 54 occur, i.e. if set point 12 value is greater than the filtered set point 13 value and phase 61 value is greater than filtered set point 13 value, the E0 is subjected to another condition of block 56. At this juncture, if phase 61 value is greater than set point 12 value, the new E0 or the treated E0 is set to be the value resulting from a difference of set point 12 value minus the phase 61 value. Otherwise, set the new E0 to zero. In other words, if phase 61 value is less than set point 12 value, set treated E0 to zero. The resultant E0 is subject to further treatment at block 62. If the conditions in block 54 are not met or do not occur, the E0 of block 52 is maintained and subject to further treatment at block 62.

If the conditions in block 62 occur, i.e. if set point 12 value is less than the filtered set point 13 value and phase 61 value is less than filtered set point 13 value, the E0 is subjected to another condition of block 64. At this juncture, if phase 61 value is less than set point 12 value, the new E0 or the treated E0 is set to be the value resulting from a difference of set point 12 value minus the phase 61 value. Otherwise, set the new E0 to zero. In other words, if phase 61 value is greater than set point 12 value, set treated E0 to zero. The resultant E0 is the treated E0 70. If the conditions in block 62 are not met or do not occur, the E0 of block 58 or block 60 are maintained as the treated E0 70.

FIG. 5 is a graphic depiction which shows the four different cases where error zero needs to be treated. Set point 12 curve is provided. The set point 12 is in turn filtered by a filter; the resultant filtered set point 13 curve is provided. The phase 61 curve, which is subject to the E0 treatment of the present invention is provided as well. Regions (1), (2), (3), and (4), which have been mentioned supra and which will be discussed in detail are provided as well. As can be seen, in region (1) When the VCT phase 61 has overshot the filtered set point 13, but not the set point 12 (i.e., in area 72 which is interposed between curve 12 and curve 13), it is desirable to keep moving towards the set point 12 to reduce the response time, the time between a set point change and the VCT reaches its commanded position. However, the VCT controller (not shown) actually pulls the VCT back towards the filtered set point 13, and causes the VCT to undershoot the filtered set point 13. The pull back is depicted in FIG. 5A by the segment 61 a of curve 61. The response time is prolonged.

The introduction of the E0 treatment cause the phase value 61 at the start of segment 61 a to be set to set point value 12 instead of filtered value 13. Thereby, curve 61 is set to the corresponding value of curve 12, instead of being commanded to meander around the proximity of curve 13,. This action can be depicted by the arrow 74.

When the VCT phase 61 has overshot both the set point 12 and the filtered set point 13 has not reached its steady state value, pulling the VCT 61 towards the set point 12 is enough. The above can be seen in region (4) in which pulling back curve 61 to curve 13 apparently wastes more time as compared to pulling curve 61 merely toward curve 12 and stops thereabout.

However, without the E0 treatment the VCT controller pulls the VCT 61 towards the filtered set point 13, which is more than required. This pulling of the VCT 61 towards filtered set point 13 is undesirable in that response time is lengthened. Therefore, by applying the E0 treatment in which curve 61 is set to set point curve 12, time lag is reduced.

It is noted that (2) of FIG. 5 is equivalent to (4) in FIG. 5 in that curve 61 undershoots or falls below both set point curve 12 and filtered set point curve 13. Therefore, using set point 12 instead of the filtered set point 13 in the neighborhood of (2) reduces the system response time.

It is further noted that (3) of FIG. 5 is equivalent to (1) in FIGS. 5 and 5A in that curve 61 is positioned between set point curve 12 and filtered set point curve 13. Therefore, using set point 12 instead of the filtered set point 13 in the neighborhood of (3) reduces the system response time.

The following is a generally applicable instruction set for error zero treatment applicable in a computer environment.

| | |
|---|---|
| - | |
| // function: | E0_treatment |
| // Input: | (1) E0: error zero, which equals the filtered set point subtracts the measured |
| phase. | |
| // | (2) SetPoint: VCT set point |
| // | (3) FilteredSetPoint: filtered VCT set point |
| // | (4) Phase: measured VCT phase |
| // Output: | (1) TreatedE0: Modified error zero |

```
    // Initialization
    TreatedE0 = E0;
    // The VCT is commanded to move towards retarding direction (larger phase
    // reading), and the phase response has overshot the filtered phase.
    if ((SetPoint > FilteredSetPoint) & (Phase > FilteredSetPoint)) {
        // case (1), the measured phase is between the set point and the filtered set
point
        if (Phase < SetPoint) {
            // set error zero to zero; wait till the filtered set point catches up.
            TreatedE0 =0;
        }
        // case 2, the measured phase has overshot the set point
        else {
            // redefine error zero to be the difference between the set point and
the
            // measured phase
            TreatedE0 = SetPoint − Phase;
        }
    }
    // The VCT is commanded to move towards advancing direction (a smaller phase
    // reading), and the phase response has overshot the filtered phase.
    if ((SetPoint < FilteredSetPoint) & (Phase < FilteredSetPoint)) {
        // case 3, the measured phase is between the set point and the filtered set
point
        if( Phase > SetPoint) {
            // set error zero to zero; wait till the filtered set point catches up.
            TreatedE0 =0;
        }
        // case 4, the measured phase has overshot the set point
        else {
            // redefine error zero to be the difference between the set point and
the phase
            TreatedE0 = SetPoint − Phase;
        }
    }
```

One embodiment of the invention is implemented as a program product for use with a computer system such as, for example, the schematics shown in FIG. 3 or a suitable engine control unit (ECU) and described below. The program(s) of the program product defines functions of the embodiments (including the methods described below with reference to FIG. 4 and can be contained on a variety of signal-bearing media. Illustrative signal-bearing media include, but are not limited to: (i) information permanently stored on in-circuit programmable devices like PROM, EPPOM, etc; (ii) information permanently stored on non-writable storage media (e.g., read-only memory devices within a computer such as CD-ROM disks readable by a CD-ROM drive); (iii) alterable information stored on writable storage media (e.g., floppy disks within a diskette drive or hard-disk drive); (iv) information conveyed to a computer by a communications medium, such as through a computer or telephone network, including wireless communications, or a vehicle controller of an automobile. Some embodiment specifically includes information downloaded from the Internet and other networks. Such signal-bearing media, when carrying computer-readable instructions that direct the functions of the present invention, represent embodiments of the present invention.

In general, the routines executed to implement the embodiments of the invention, whether implemented as part of an operating system or a specific application, component, program, module, object, or sequence of instructions may be referred to herein as a “program”. The computer program typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

The following are terms and concepts relating to the present invention.

It is noted the hydraulic fluid or fluid referred to supra are actuating fluids. Actuating fluid is the fluid which moves the vanes in a vane phaser. Typically the actuating fluid includes engine oil, but could be separate hydraulic fluid. The VCT system of the present invention may be a Cam Torque Actuated (CTA)VCT system in which a VCT system that uses torque reversals in camshaft caused by the forces of opening and closing engine valves to move the vane. The control valve in a CTA system allows fluid flow from advance chamber to retard chamber, allowing vane to move, or stops flow, locking vane in position. The CTA phaser may also have oil input to make up for losses due to leakage, but does not use engine oil pressure to move phaser. Vane is a radial element actuating fluid acts upon, housed in chamber. A vane phaser is a phaser which is actuated by vanes moving in chambers.

There may be one or more camshaft per engine. The camshaft may be driven by a belt or chain or gears or another camshaft. Lobes may exist on camshaft to push on valves. In a multiple camshaft engine, most often has one shaft for exhaust valves, one shaft for intake valves. A “V” type engine usually has two camshafts (one for each bank) or four (intake and exhaust for each bank).

Chamber is defined as a space within which vane rotates. Camber may be divided into advance chamber (makes valves open sooner relative to crankshaft) and retard chamber (makes valves open later relative to crankshaft). Check valve is defined as a valve which permits fluid flow in only one direction. A closed loop is defined as a control system which changes one characteristic in response to another, then checks to see if the change was made correctly and adjusts the action to achieve the desired result (e.g. moves a valve to change phaser position in response to a command from the ECU, then checks the actual phaser position and moves valve again to correct position). Control valve is a valve which controls flow of fluid to phaser. The control valve may exist within the phaser in CTA system. Control valve may be actuated by oil pressure or solenoid. Crankshaft takes power from pistons and drives transmission and camshaft. Spool valve is defined as the control valve of spool type. Typically the spool rides in bore, connects one passage to another. Most often the spool is most often located on center axis of rotor of a phaser.

Differential Pressure Control System (DPCS) is a system for moving a spool valve, which uses actuating fluid pressure on each end of the spool. One end of the spool is larger than the other, and fluid on that end is controlled (usually by a Pulse Width Modulated (PWM) valve on the oil pressure), full supply pressure is supplied to the other end of the spool (hence differential pressure). Valve Control Unit (VCU) is a control circuitry for controlling the VCT system. Typically the VCU acts in response to commands from ECU.

Driven shaft is any shaft which receives power (in VCT, most often camshaft). Driving shaft is any shaft which supplies power (in VCT, most often crankshaft, but could drive one camshaft from another camshaft). ECU is Engine Control Unit that is the car's computer. Engine Oil is the oil used to lubricate engine, pressure can be tapped to actuate phaser through control valve.

Housing is defined as the outer part of phaser with chambers. The outside of housing can be pulley (for timing belt), sprocket (for timing chain) or gear (for timing gear). Hydraulic fluid is any special kind of oil used in hydraulic cylinders, similar to brake fluid or power steering fluid. Hydraulic fluid is not necessarily the same as engine oil. Typically the present invention uses “actuating fluid”. Lock pin is disposed to lock a phaser in position. Usually lock pin is used when oil pressure is too low to hold phaser, as during engine start or shutdown.

Oil Pressure Actuated (OPA) VCT system uses a conventional phaser, where engine oil pressure is applied to one side of the vane or the other to move the vane.

Open loop is used in a control system which changes one characteristic in response to another (say, moves a valve in response to a command from the ECU) without feedback to confirm the action.

Phase is defined as the relative angular position of camshaft and crankshaft (or camshaft and another camshaft, if phaser is driven by another cam). A phaser is defined as the entire part which mounts to cam. The phaser is typically made up of rotor and housing and possibly spool valve and check valves. A piston phaser is a phaser actuated by pistons in cylinders of an internal combustion engine. Rotor is the inner part of the phaser, which is attached to a cam shaft.

Pulse-width Modulation (PWM) provides a varying force or pressure by changing the timing of on/off pulses of current or fluid pressure. Solenoid is an electrical actuator which uses electrical current flowing in coil to move a mechanical arm. Variable force solenoid (VFS) is a solenoid whose actuating force can be varied, usually by PWM of supply current. VFS is opposed to an on/off (all or nothing) solenoid.

Sprocket is a member used with chains such as engine timing chains. Timing is defined as the relationship between the time a piston reaches a defined position (usually top dead center (TDC)) and the time something else happens. For example, in VCT or VVT systems, timing usually relates to when a valve opens or closes. Ignition timing relates to when the spark plug fires.

Torsion Assist (TA)or Torque Assisted phaser is a variation on the OPA phaser, which adds a check valve in the oil supply line (i.e. a single check valve embodiment) or a check valve in the supply line to each chamber (i.e. two check valve embodiment). The check valve blocks oil pressure pulses due to torque reversals from propagating back into the oil system, and stop the vane from moving backward due to torque reversals. In the TA system, motion of the vane due to forward torque effects is permitted; hence the expression “torsion assist” is used. Graph of vane movement is step function.

VCT system includes a phaser, control valve(s), control valve actuator(s) and control circuitry. Variable Cam Timing (VCT) is a process, not a thing, that refers to controlling and/or varying the angular relationship (phase) between one or more camshafts, which drive the engine's intake and/or exhaust valves. The angular relationship also includes phase relationship between cam and the crankshafts, in which the crank shaft is connected to the pistons.

Variable Valve Timing (VVT) is any process which changes the valve timing. VVT could be associated with VCT, or could be achieved by varying the shape of the cam or the relationship of cam lobes to cam or valve actuators to cam or valves, or by individually controlling the valves themselves using electrical or hydraulic actuators. In other words, all VCT is VVT, but not all VVT is VCT.

Accordingly, it is to be understood that the embodiments of the invention herein described are merely illustrative of the application of the principles of the invention. Reference herein to details of the illustrated embodiments are not intended to limit the scope of the claims, which themselves recite those features regarded as essential to the invention.

1. In a VCT control system having a predetermined set point with a set point value and a set point filter filtering the set point and deriving a filtered set point value, the control system generates an error signal by subtracting the measured phase value from the filtered set point value, the control system has a control law for processing the error signal, and the control system further has a method for modifying the error signal for reducing the excessive VCT response time caused by VCT undershooting its filtered set point, the method comprising the steps of:
providing an initial error;
setting the initial error as the error
subtracting the set point value from a phase value if a first set of conditions are met; and
setting the difference of the above step as the error.

2. The method of claim 1 further comprising the steps of:
subtracting the phase value from the set point value if a second set of conditions are met; and
setting the difference of the above step as the error.

3. The method of claim 2, wherein the second set of conditions comprising:
the set point value is less than filtered set point value, and the phase value is less than the filtered set point value as well; and
the phase value is less than the set point value.

4. The method of claim 1 further comprising the steps of setting the error to zero if a third set of conditions are met.

5. The method of claim 1 further comprising the steps of keeping the initial error as the error if a fourth set of conditions are met.

6. The method of claim 1, wherein the first set of conditions comprising:
the set point value is greater than filtered set point value, and the phase value is greater than the filtered set point value as well; and
the phase value is greater than the set point value.

7. A VCT control system comprising:
a predetermined set point with a set point value;
a set point filter filtering the set point and deriving a filtered set point value;
an error signal generated by the control system through subtracting the measured phase value from the filtered set point value; and
an error zero treatment block having the set point value and the filtered set point value, the error zero treatment block comprising a method generating an error signal for reducing the excessive VCT response time caused by VCT undershooting its filtered set point, the method comprising the steps of:
providing an initial error;
setting the initial error as the error
subtracting the set point value from a phase value if a first set of conditions are met; and
setting the difference of the above step as the error.

8. The system of claim 7 wherein the method further comprising the steps of:
subtracting the set point value from a phase value if a second set of conditions are met; and
setting the difference of the above step as the error.

9. The system of claim 8, wherein the second set of conditions comprising:
the set point value is less than filtered set point value, and the phase value is less than the filtered set point value as well; and
the phase value is less than the set point value.

10. The system of claim 7, wherein the method further comprising the steps of setting the error to zero if a third set of conditions are met.

11. The system of claim 7, wherein the method further comprising the steps of keeping the initial error as the error if a fourth set of conditions are met.

12. The method of claim 7, wherein the first set of conditions comprising:
the set point value is greater than filtered set point value, and the phase value is greater than the filtered set point value as well; and
the phase value is greater than the set point value.
